(19) United States
(12) Patent Application Publication
(10) Pub. No.: US 2024/0305836 A1
(43) Pub. Date: Sep. 12, 2024

(54) METHODS, APPARATUS, ELECTRONIC DEVICE AND STORAGE MEDIUM FOR CLOUD RENDERING OF A LIVE STREAM GIFT

(71) Applicant: Beijing Zitiao Network Technology Co., Ltd., Beijing (CN)

(72) Inventors: Qi Zhao, Beijing (CN); Shiyang Zhang, Beijing (CN); Yanhao Shen, Beijing (CN); Jiuling Xian, Beijing (CN); Yuanyuan Wang, Beijing (CN)

(21) Appl. No.: 18/574,293

(22) PCT Filed: Sep. 21, 2022
(86) PCT No.: PCT/CN2022/120226

§ 371 Date: Dec. 26, 2023

(30) Foreign Application Priority Data
Sep. 27, 2021 (CN) 202111138580.7

(51) Int. Cl. H04N 21/2187; H04N 21/431

(52) U.S. Cl. CPC H04N 21/2187; H04N 21/4312

(57) ABSTRACT

The disclosure provides a method, apparatus, electronic device, and storage medium for cloud rendering of a live stream gift, wherein the method applied to the client includes: obtaining a to-be-rendered gift identifier and determining an attribute value of a gift effect corresponding to the identifier; uploading, based on the attribute value, the identifier, and a current live stream interface view to a target server, to cause the target server to perform rendering processing on the current live stream interface view based on a gift effect rendering algorithm corresponding to the identifier; and receiving and displaying a view rendering result issued by the target server.

The present disclosure claims priority to Chinese Patent Application No. 202111138580.7, filed with the Chinese Patent Office on Sep. 27, 2021, which is incorporated herein by reference in its entirety.

### FIELD

Embodiments of the present disclosure relates to the technical field of live streaming, for example, to a method, apparatus, electronic device, and storage medium for cloud rendering of a live stream gift.

### BACKGROUND

In the process of live streaming, it is generally displayed in the form of graphical effects to send a gift to an anchor. In order to improve live stream gifts, the quality of rendering, and the richness of the display content, perform the effects rendering on the to-be-displayed gifts and display them in the mostly adopted way of loading effects plug-ins in the live stream client.

However, this kind of method of gift effect rendering has certain performance requirements for mobile devices. For devices with insufficient computing performance, the lack of computing and rendering performance may result in poor-quality rendering. If the quality of rendering of a live stream gift is to be improved, the coverage of devices capable of performing high-quality rendering of a live stream gift will be reduced, and this problem has yet to be solved.

### SUMMARY

Embodiments of the present disclosure provide a method, apparatus, electronic device, and storage medium for cloud rendering of a live stream gift. It can complete complex gift effect rendering at a server, reducing complex effect rendering pressure on the client, and bringing high-quality rendering effects and richer effects content for effect users, causing the complex effect function to cover more devices.

In a first aspect, embodiments of the present disclosure provide a method for cloud rendering of a live stream gift, applied to the client, the method comprising:
obtaining a to-be-rendered gift identifier and determining an attribute value of a gift effect corresponding to the identifier;
uploading, based on the attribute value, the identifier, and a current live stream interface view to a target server, to cause the target server to perform rendering processing on the current live stream interface view based on a gift effect rendering algorithm corresponding to the identifier; and
receiving and displaying a view rendering result issued by the target server.

In a second aspect, embodiments of the present disclosure provide a method for cloud rendering of a live stream gift, applied to the server, the method comprising:
obtaining a to-be-rendered gift identifier uploaded by a live stream client that sends a gift request, and a target rendering processing image;
performing rendering processing on the target rendering processing image by a gift effect rendering algorithm corresponding to the identifier; and
sending an image rendering result to a target client for display, wherein the target client comprises the live stream client that sends the gift request and a live stream client associated with the live stream client that sends the gift request.

In a third aspect, embodiments of the present disclosure further provide an apparatus for cloud rendering of a live stream gift configured to the client, the apparatus comprising:
a rendering attribute determination module configured to obtain a to-be-rendered gift identifier and determining an attribute value of a gift effect corresponding to the identifier;
a cloud rendering initiation module configured to upload, based on the attribute value, the identifier, and a current live stream interface view to a target server, to cause the target server to perform rendering processing on the current live stream interface view based on a gift effect rendering algorithm corresponding to the identifier; and
a rendering result display module configured to receive and display a view rendering result issued by the target server.

In a fourth aspect, embodiments of the present disclosure further provide an apparatus for cloud rendering of a live stream gift configured to the server, the apparatus comprising:
a cloud rendering startup module configured to obtain a to-be-rendered gift identifier uploaded by a live stream client that sends a gift request, and a target rendering processing image;
a cloud rendering module configured to a perform rendering processing on the target rendering processing image by the gift effect rendering algorithm corresponding to the identifier; and
a cloud rendering result feedback module configured to send an image rendering result to a target client for display, wherein the target client comprises the live stream client that send a gift request and a live stream client associated with the live stream client that send a gift request.

In a fifth aspect, embodiments of the present disclosure further provide an electronic device, comprising:
one or more processors; and
a storage apparatus configured to store one or more programs;
wherein the one or more programs, when executed by the one or more processors, cause the one or more processors to implement the method for cloud rendering of a live stream gift based on any one of embodiments of the present disclosure.

In a sixth aspect, embodiments of the present disclosure further provide a storage medium comprising computer-executable instructions, the computer-executable instructions, when executed by a computer processor, causing the method for cloud rendering of a live stream gift based on any one of embodiments of the present disclosure.

### BRIEF DESCRIPTION OF THE DRAWINGS

FIG. 1 shows a schematic flowchart of a method for cloud rendering of a live stream gift applied to a client provided by an embodiment of the present disclosure;

FIG. 2 shows a schematic flowchart of a method for cloud rendering of a live stream gift applied to a server provided by an embodiment of the present disclosure;

FIG. 3 shows a structural schematic diagram of an apparatus for cloud rendering of a live stream gift configured on the client provided by an embodiment of the present disclosure;

FIG. 4 shows a structural schematic diagram of an apparatus for cloud rendering of a live stream gift configured on the server provided by an embodiment of the present disclosure; and

FIG. 5 shows a structural schematic diagram of an electronic device provided by an embodiment of the present disclosure.

### DETAILED DESCRIPTION

It should be understood that the various steps documented in the method embodiments of the present disclosure may be performed in a different order, and/or in parallel. In addition, the method embodiments may comprise additional steps and/or omit performing the illustrated steps. The scope of the present disclosure is not limited in this regard.

As used herein, the term “comprises” and its variations are open-ended, i.e., “comprising, but not limited to”. The term “based on” is “based at least partially on”. The term “one embodiment” represents “at least one embodiment”; the term “another embodiment” represents “at least one additional embodiment”; the term “some embodiments” represents “at least some embodiments”. Related definitions of other terms will be given in the description below.

It should be noted that references to the concepts of “first”, “second” and the like in the present disclosure are only used to distinguish different apparatuses, modules, or units, and are not intended to limit the order or interdependence of the functions performed by these apparatuses, modules, or units.

It should be noted that references to the qualifications “one” and “a plurality of” in the present disclosure are schematic rather than limiting. It should be understood by those skilled in the art that the term “one or more” should be understood unless the context clearly indicates otherwise.

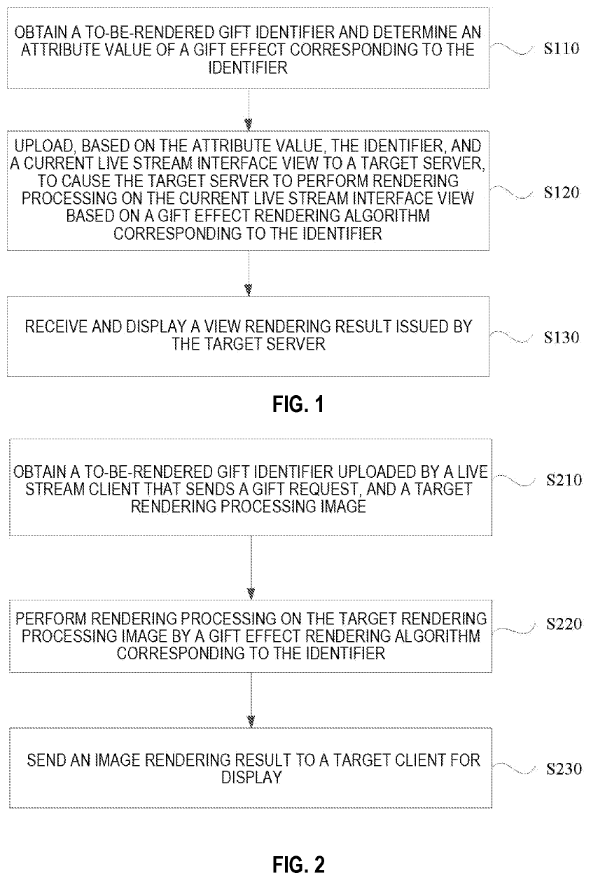

FIG. 1 shows a schematic flowchart of a method for cloud rendering of a live stream gift applied to a client provided by an embodiment of the present disclosure. Embodiments of the present disclosure are applicable to the case of performing effect rendering and displaying on gifts sent to anchors during the process of live streaming. The method can be performed by an apparatus for cloud rendering of a live stream gift, which is implemented by the form of software and/or hardware. The apparatus can be configured in an electronic device, such as a mobile terminal or a server device.

As shown in FIG. 1, the present embodiment provides a method for cloud rendering of a live stream gift applied to the client, comprising:
S110. Obtain a to-be-rendered gift identifier and determine an attribute value of a gift effect corresponding to the identifier.

In the process of live streaming, the client of live streaming application comprises an anchor client and an audience client. The audience client can send gifts to the anchor during the process of live streaming to express their liking and support for the anchor and its live streaming content. The effects of a gift are presented in various ways, comprising static or dynamic gift presentation effects. Respective different gift themes should also be presented in different ways, such as flying angel wings, speeding cars, or accessories that match the anchor's portrait in the live streaming interface.

The attribute value of a gift effect comprises the algorithm complexity of gift rendering, the data volume of gift effect rendering resources, and/or the performing subject of a gift rendering setting. A plurality of attribute values can be used to determine whether a gift effect needs to be rendered by a cloud server, in order to complete the effect rendering process more efficiently and smoothly.

For example, the process of obtaining a to-be-rendered gift identifier is that during the process of live streaming of the anchor, the audience selects and triggers any effect gift on the client interface, and the identifier of the gift is the to-be-rendered gift identifier. The client that sends the gift can also be called the gift-giving client. Therefore, after the gift-giving client sends the gift, the gift-giving client and live streaming clients comprising the anchor and other audiences will also obtain the to-be-rendered gift identifier through the live streaming backend.
S120. Upload, based on the attribute value, the identifier, and a current live stream interface view to a target server, to cause the target server to perform rendering processing on the current live stream interface view based on a gift effect rendering algorithm corresponding to the identifier.

When any attribute value of the gift effect corresponding to the to-be-rendered gift identifier indicates that it needs to be rendered by the server, the to-be-rendered gift identifier and the current live stream interface view can be uploaded to the target server. The target server is a server that can be used to run the gift effect rendering algorithm, such as a dedicated server.

For example, some gift effect animations deal with more complex gift effects, i.e., the algorithm content for implementing gift effect rendering is numerous and complex. For example, effect rendering is performed based on the live streaming interface view, and the picture style (Chinese animation style, Japanese animation style) is transformed based on the live stream interface view, and dynamic effect is added. A plurality of styles can further be changed to a view at the same time, and the transformation results of the plurality of styles can be linked and displayed. In the process of running the gift effect rendering algorithm, the system overhead is high, which requires a certain environment to run the effect rendering algorithm. Some terminal devices with insufficient computing performance may experience stuttering if they cannot run the gift effect rendering algorithm smoothly, and the gift effect cannot meet expectations, which will affect the visual effect viewed by the client user. Therefore, when the attribute value of the complexity of the gift effect rendering algorithm reaches the predetermined cloud rendering complexity criterion, a gift effect rendering request needs to be sent to the target server, and the target server needs to be informed of the gift effect algorithm to be run and the corresponding rendering object. That is to upload the to-be-rendered gift identifier and the current live stream interface view to the target server, so that the target server matches the corresponding gift effect rendering algorithm based on the to-be-rendered gift identifier and performs rendering processing on the current live stream interface view based on the matched algorithm.

For example, the complexity of the algorithm can be judged by the size of the gift effect rendering algorithm file corresponding to the to-be-rendered gift identifier. Generally, the larger the file, the more algorithm content it contains, and the more complex it will be. Alternatively, based on indicators such as the number of lines of the effect rendering algorithm and the complexity of the invoking relationship, the respective gift effect algorithm file can be evaluated and labeled with a complexity level of the algorithm. When the client recognizes the to-be-rendered gift identifier, it can query the complexity of the effect rendering algorithm of the to-be-rendered gift and obtain the attribute value.

In addition, the current live stream interface view can be obtained by the client's screenshot props to the live streaming interface screenshot, the screenshot can be a pure live streaming interface without real-time audience interaction messages and other functional controls, and with only the anchor image information in the interface.

For example, in order to save internet bandwidth resources, it can be pre-agreed and set up, and only requires the gift client to upload the current live stream interface view. Other clients only need to query and obtain image rendering results from the target server based on the to-be-rendered gift identifier.

For example, during the gift effect rendering at the target server, the client (the anchor client and the audience client comprising the gift-giving client) that is required to display the effect rendering results can play the effect teaser animation corresponding to the to-be-rendered gift identifier until the view rendering result issued by the target server is received. The effect teaser animation is a pre-configured animation that matches the to-be-rendered gift. It can be an animation introduction animation that can be joined with the rendering result or other simple effect animations that can fill the gaps during the waiting for the gift effect rendering result. The effect teaser animation can be played repeatedly while waiting for the gift effect rendering result.
S130. Receive and display a view rendering result issued by the target server.

When the target server completes the gift effect rendering work, the corresponding view rendering result will be sent back to the client, the client displays the final gift effects. Through the technical solution of the present embodiment. For devices with insufficient algorithm processing performance, it is possible to smoothly display more complex gift effect rendering results.

For example, if the target server is not received within a predetermined length of time issued by the view rendering result, it indicates that the target server may be due to network failure or other reasons, failed to successfully complete the gift effect rendering, the client can play the alternative effect animation corresponding to the to-be-rendered gift identifier.

In order to further reduce the bandwidth cost and reduce the interaction between the client and the target server, when obtaining the to-be-rendered gift identifier, the client will also recognize the computing performance of the device it is on, which can be judged based on the device model, device processor parameters, or device remaining Random Access Memory parameters and corresponding standards. When the computing performance of the device where any client is located reaches the standard of running the gift effect rendering algorithm corresponding to the to-be-rendered gift identifier, the current live stream interface view can be intercepted, and the gift effect rendering algorithm corresponding to the to-be-rendered gift identifier can be used to complete the gift effect rendering algorithm locally and display the rendering result. Herein, the gift effect rendering algorithm can request and obtain the corresponding gift effect rendering algorithm from the target server based on the to-be-rendered gift identifier. For the gift-giving client, even if the terminal device where the gift-giving client is located can complete the gift effect rendering locally, it will take a screenshot of the live streaming interface and upload it to the target server to provide rendering objects for the target server.

The technical solution of the present disclosure can determine the attribute value of the corresponding gift effect when a live stream viewer sends a gift (i.e., a to-be-rendered gift) and the client obtains the to-be-rendered gift identifier; and then based on the attribute value, judge whether the gift effect rendering process needs to be processed in the cloud, for example, when the complexity of the effect gift effect rendering algorithm reaches the predetermined cloud rendering complexity criterion, the to-be-rendered gift identifier and the current live stream interface view are uploaded to the target server so that the target server can render the current live stream interface view based on the gift effect rendering algorithm corresponding to the to-be-rendered gift identifier, and obtain the gift effect rendering result; finally, the client can receive and display the view rendering result issued by the target server (i.e., the gift effect rendering result). For example, the client can also complete the gift effect rendering locally based on the performance of the terminal device where it is located, reducing interaction with the target rendering server, and thereby reducing bandwidth occupancy. The technical solution of the present disclosure avoids the low coverage of devices that can perform high-quality and content-rich live stream gift effect rendering in the process of live streaming, implements the completion of complex gift effect rendering at the server, reduces the pressure of complex effect rendering on the client, and brings high-quality rendering effects and richer effect content to effect users, causing complex effect functions to cover more devices.

The embodiments of the present disclosure provide a method for cloud rendering of a live stream gift applied to a server, which belongs to the same inventive concept as the method for cloud rendering of a live stream gift applied to a client provided in the above embodiments. The method for cloud rendering of a live stream gift applied to the server provided in the present embodiment further describes the process of rendering gift effects at the server for live stream rendering gifts in the process of live streaming. The method can be performed by a device configured on the server apparatus for cloud rendering of live stream gift, which can be implemented in the form of software and/or hardware, and the device can be configured in a server device.

FIG. 2 shows a schematic flowchart of a method for cloud rendering of a live stream gift applied to a server provided by an embodiment of the present disclosure. As shown in FIG. 2, the method for cloud rendering of a live stream gift provided by the present embodiment comprises:
S210. Obtain a to-be-rendered gift identifier uploaded by a live stream client that sends a gift request, and a target rendering processing image.

Herein, the live stream client that sends a gift request is the gift-giving client. When the gift-giving client sends a gift to the anchor, the gift-giving client determines that the gift effect rendering algorithm corresponding to the to-be-rendered gift identifier needs to run at the server and will send a gift effect rendering request to the server. The information synchronized with the gift effect rendering request also comprises the to-be-rendered gift identifier and the target rendering processing image. The target rendering processing image is a screenshot of the live streaming interface obtained by the client by the client's screenshot props. The screenshot can be a pure live streaming interface without real-time audience interaction messages and other functional controls, and only with anchor image information in the interface.
S220. Perform rendering processing on the target rendering processing image by a gift effect rendering algorithm corresponding to the identifier.

When the content of the target rendering processing image get approved, the server will start at least one worker thread to perform the gift effect rendering algorithm, so as to complete the rendering processing of the target rendering processing image.

For example, the server can start at least one thread to synchronize rendering processing of target rendering processing images through content approval based on the gift effect rendering algorithm content corresponding to the to-be-rendered gift identifier. In addition, the server can further synchronously start a plurality of worker threads to render processing of a plurality of target rendering processing images.
S230. Send an image rendering result to a target client for display.

Herein, the target client comprises the live stream client that sends the gift request and a live stream client associated with the live stream client that sends the gift request, i.e., the anchor client, the gift client, and other audience clients besides the gift-giving client. After obtaining the to-be-rendered gift identifier, the client will send, based on the identifier, a query for the rendering result to the server in accordance with a predetermined frequency. The server determines the target client based on the query request of the obtained rendering result and sends the rendering result to the target client for display.

For example, the client will also send a rendering end notification message to the target client to inform the target client that the image rendering results can be displayed.

In the technical solution of an embodiment of the present disclosure, a request from the client for a gift effect rendering request is obtained by the server, and the target gift effect is rendered and sent to the target client for displaying the gift effect. Herein, the rendered target gift effect is a complex gift effect that has been evaluated by the client. As a result, users who log in to the client on different devices can view the complex and high-quality gift effects. The technical solution of the present disclosure avoids the low coverage of devices that can perform high-quality and content-rich live stream gift effect rendering in the process of live streaming, implements complex gift effect rendering at the server, reduces the complex effect rendering pressure on the client, and brings high-quality rendering effects and richer effect content to effect users.

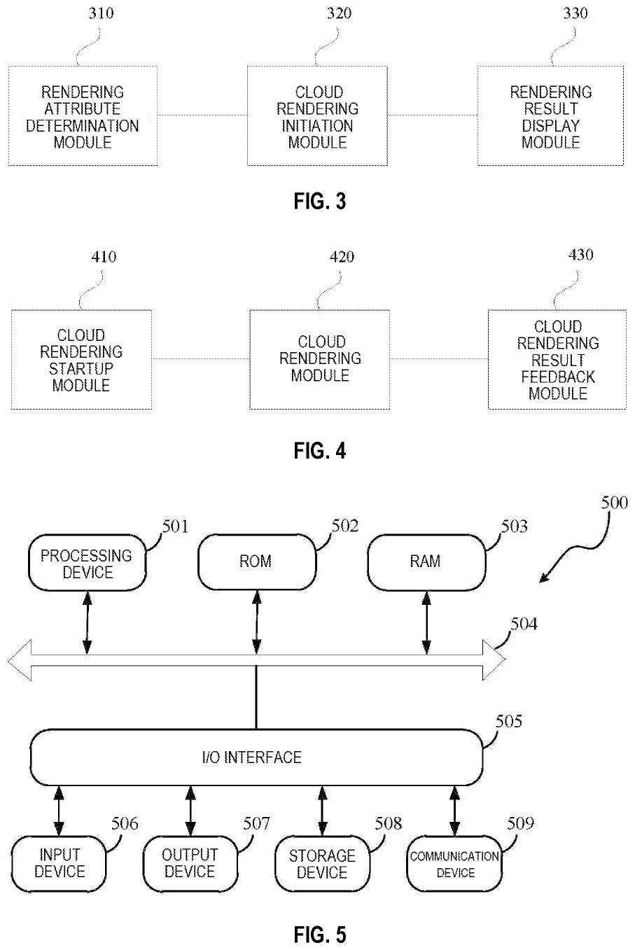

FIG. 3 shows a structural schematic diagram of an apparatus for cloud rendering of a live stream gift configured on the client provided by an embodiment of the present disclosure. The apparatus for cloud rendering of a live stream gift configured on the client provided in the present embodiment is suitable for the case of rendering and displaying effects on gifts sent to the anchor during the process of live streaming.

As shown in FIG. 3, the apparatus for cloud rendering of a live stream gift configured on the client comprises: a rendering attribute determination module 310, a cloud rendering initiation module 320 and a rendering result display module 330.

Herein, the rendering attribute determination module 310 is configured to obtain a to-be-rendered gift identifier and determining an attribute value of a gift effect corresponding to the identifier; the cloud rendering initiation module 320 is configured to upload, based on the attribute value, the identifier, and a current live stream interface view to a target server, to cause the target server to perform rendering processing on the current live stream interface view based on a gift effect rendering algorithm corresponding to the identifier; and the rendering result display module 330 is configured to receive and display a view rendering result issued by the target server.

In the technical solution of the present disclosure, when a live stream viewer sends a gift (i.e., a to-be-rendered gift), and the client obtains a to-be-rendered gift identifier, the attribute value of the corresponding gift effect is determined; when the effect rendering needs to be performed in the cloud based on the attribute value, the to-be-rendered gift identifier and the current live stream interface view are uploaded to the target server, causing the target server to render the current live stream interface view based on the effect gift effect rendering algorithm corresponding to the to-be-rendered gift identifier, to obtain the gift effect rendering result; finally, the client can receive and display the view rendering result (i.e., the gift effect rendering result) issued by the target server. The technical solution of the embodiments of the present disclosure avoids the low coverage of devices capable of rendering high-quality and content-rich live streaming gift effects during the live streaming process in the related technology and implements the completion of complex gift effect rendering at the server, reduces the client complex effects rendering pressure, brings high-quality rendering effects and richer effects content to the effect users, and enables the complex effects to function to cover more device.

For example, the attribute value comprises a gift effect rendering algorithm complexity, the cloud rendering initiation module 320 is configured to:
in accordance with a determination that the gift effect rendering algorithm complexity reaches a predetermined cloud rendering complexity criterion, upload the identifier and the current live stream interface view to the target server.

For example, the cloud rendering initiation module 320 is further configured to: in accordance with a determination that the gift effect rendering algorithm complexity reaches a predetermined cloud rendering complexity criterion, play an effect teaser animation corresponding to the identifier until the view rendering result issued by the target server is received.

For example, the rendering result display module 330 is further configured to:
in accordance with a determination that the view rendering result issued by the target server has not been received within a predetermined period, play an alternative effect animation corresponding to the identifier.

For example, the apparatus for cloud rendering of live stream gift configured on the client further comprises a local rendering module configured to:
when obtaining a to-be-rendered gift identifier, identify a computing performance of a device where the client is located;
in accordance with a determination that the computing performance satisfies a criterion for running a gift effect rendering algorithm corresponding to the identifier, capture the current live stream interface view, and obtain the gift effect rendering algorithm corresponding to the identifier; and
render the current live stream interface view based on the gift effect rendering algorithm corresponding to the identifier and displaying the rendering result.

The apparatus for cloud rendering of live stream gift configured on a client provided in embodiments of the present disclosure may perform a method of cloud rendering of a live stream gift applied provided in any embodiment of the present disclosure to the client and possesses functional modules and beneficial effects corresponding to the performing of the method.

It should be noted that the above apparatus comprises a plurality of units and modules that are divided based on functional logic, but are not limited to the above division, as long as they can implement the corresponding functions; in addition, the specific names of the plurality of functional units are only for the purpose of facilitating differentiation between each other and are not intended to limit the scope of protection of the embodiments of the present disclosure.

FIG. 4 shows a structural schematic diagram of an apparatus for cloud rendering of a live stream gift configured on the server provided by an embodiment of the present disclosure. The apparatus for cloud rendering of live stream gift configured on a server provided by the present embodiment is suitable for the process of performing gift effect rendering on the server, used to live stream rendering, in the process of live streaming.

As shown in FIG. 4, the apparatus for cloud rendering of live stream gift configured on a server comprises: a cloud rendering startup module 410, a cloud rendering module 420 and a cloud rendering result feedback module 430.

Herein, the cloud rendering startup module 410 is configured to obtain a to-be-rendered gift identifier uploaded by a live stream client that sends a gift request, and a target rendering processing image; the cloud rendering module 420 is configured to a perform rendering processing on the target rendering processing image by the gift effect rendering algorithm corresponding to the identifier; and the cloud rendering result feedback module 430 is configured to send an image rendering result to a target client for display, wherein the target client comprises the live stream client that send a gift request and a live stream client associated with the live stream client that send a gift request.

In the technical solution of an embodiment of the present disclosure, a request from the client for a gift effect rendering request is obtained by the server, and the target gift effect is rendered and sent to the target client for displaying the gift effect. Herein, the rendered target gift effect is a complex gift effect that has been evaluated by the client. As a result, users who log in to the client on different devices can view the complex and high-quality gift effects. The technical solution of the present disclosure avoids the low coverage of devices that can perform high-quality and content-rich live stream gift effect rendering in the process of live streaming, implements complex gift effect rendering at the server, reduces the complex effect rendering pressure on the client, and brings high-quality rendering effects and richer effect content to effect users.

For example, the cloud rendering module 420 is configured to:
perform, by starting at least one thread, synchronous rendering processing on the target rendering processing image that passes a content review, based on content of the gift effect rendering algorithm corresponding to the identifier.

For example, the cloud rendering result feedback module 430 is configured to:
send an end-of-rendering notification message to the target client to cause the target client to display the image rendering result.

The apparatus for cloud rendering of live stream gift configured on a server provided in embodiments of the present disclosure may perform a method of cloud rendering of a live stream gift applied provided in any embodiment of the present disclosure to the server and possesses functional modules and beneficial effects corresponding to the performing of the method.

It should be noted that the above apparatus comprises a plurality of units and modules that are divided based on functional logic, but are not limited to the above division, as long as they can implement the corresponding functions; in addition, the specific names of the plurality of functional units are only for the purpose of facilitating differentiation between each other and are not intended to limit the scope of protection of the embodiments of the present disclosure.

Referring to FIG. 5, a schematic diagram of a structure of an electronic device (e.g., a terminal device or a server in FIG. 5) 500 suitable for use in implementing embodiments of the present disclosure is shown. The terminal device in embodiments of the present disclosure may comprise an electronic device such as a cell phone, a laptop computer, a digital broadcast receiver, a Personal Digital Assistant (PDA), a Portable Android Device (PAD), a Portable Media Player (PMP), an in-vehicle terminal (e.g., an in-vehicle navigation terminal), and the like, and fixed terminals such as a digital television (TV), a desktop computer, and the like. The electronic device illustrated in FIG. 5 is merely an example and should not impose any limitations on the functionality and scope of use of the embodiments of the present disclosure.

As shown in FIG. 5, the electronic device 500 may comprise a processing device (e.g., a central processor, a graphics processor, etc.) 501, which may perform a variety of appropriate actions and processes based on a program stored in Read-Only Memory (ROM) 502 or loaded from the storage device 506 into Random Access Memory (RAM) 503 to perform various appropriate actions and processes. Various programs and data required for operation of the electronic device 500 are also stored in the RAM 503. The processing device 501, the ROM 502, and the RAM 503 are connected to respective other via the bus 504. An input/output (I/O) interface 505 is also connected to bus 504.

Generally, the following devices may be connected to the I/O interface 505: an input device 506 comprising, for example, a touch screen, a touch pad, a keyboard, a mouse, a video camera, a microphone, an accelerometer, a gyroscope, and the like; an output device 507 comprising, for example, a liquid crystal display (LCD), a speaker, a vibrator, and the like; a storage device 508 comprising, for example, a magnetic tape, a hard disk, and the like; and a communication device 509. The communication device 509 may allow the electronic device 500 to communicate wirelessly or wiredly with other devices to exchange data. Although FIG. 5 illustrates electronic device 500 with various devices, it should be understood that it is not required to implement or have all of the illustrated devices. More or fewer devices may alternatively be implemented or possessed.

For example, based on embodiments of the present disclosure, the process described with reference to the flowchart above may be implemented as a computer software program. For example, embodiments of the present disclosure comprise a computer program product comprising a computer program anchored on a non-transitory computer-readable medium, the computer program comprising program code for executing the method shown in the flowchart. In such embodiments, the computer program may be downloaded and installed from a network via the communication device 509, or from the storage device 506, or from the ROM 502. When the computer program is executed by the processing device 501, the above functions defined in the method of the embodiments of the present disclosure are performed.

The electronic device provided by the embodiments of the present disclosure belongs to the same public concept as the method for cloud rendering of a live stream gift applied to a server or a client provided by the above embodiments. The technical details not exhaustively described in the present embodiments can be found in the above embodiments, and the present embodiments and the above embodiments have the same beneficial effects.

Embodiments of the present disclosure provide a computer storage medium storing computer program thereon, the computer programs, when executed by a processor, implements the method for cloud rendering of live stream gift based on the above embodiments applied to a client or a server.

It should be noted that the computer-readable medium described above in the present disclosure may be a computer-readable signal medium or a computer-readable storage medium or any combination thereof. The computer-readable storage medium may, for example, be—but is not limited to—a system, device, or apparatus or device of electricity, magnetism, light, electromagnetism, infrared, or semiconductors, or an electrical connection of any one or more wires, or a combination of the above. More specific examples of computer-readable storage media may comprise but are not limited to: an electrically connected portable computer disk with one or more leads, hard disk, random access memory (RAM), read-only memory (ROM), erasable programmable read-only memory (EPROM) or flash memory (FLASH), optical fiber, compact disk read-only memory (CD-ROM) optical storage device, magnetic storage device, or any suitable combination of the foregoing. In the present disclosure, a computer-readable storage medium may be any tangible medium that contains or stores a program that may be used by or in combination with an instruction execution system, apparatus, or component. And in the present disclosure, a computer-readable signal medium may comprise a data signal propagated in a baseband or as part of a carrier carrying computer-readable program code. Such propagated data signals may adopt a variety of forms, comprising but not limited to electromagnetic signals, optical signals, or any suitable combination of the foregoing. The computer-readable signal medium may also be any computer-readable medium other than a computer-readable storage medium that sends, disseminates, or transmits a program for use by, or in conjunction with, an instruction-executing system, apparatus, or device. The program code included on the computer-readable medium may be transmitted using any suitable medium, comprising, but not limited to, wire, fiber optic cable, radio frequency (RF), etc., or any suitable combination thereof.

In some implementations, clients, servers may communicate with any currently known or future developed network protocol such as HyperText Transfer Protocol (HTTP) and may be interconnected with any form or medium of digital data communication (e.g., a communications network). Examples of communication networks comprise Local Area Networks (LAN), Wide Area Networks (WAN), Internet (e.g., the Internet), and End-to-End Networks (e.g., ad hoc End-to-End Networks), as well as any currently known or future developed networks.

The computer-readable medium may be included in the above-mentioned electronic device; it may also exist separately and not be assembled into the electronic device.

The computer-readable medium carries one or more programs that, when the one or more programs are executed by the electronic device, enable the electronic device:
obtain a to-be-rendered gift identifier and determine an attribute value of a gift effect corresponding to the identifier;
upload, based on the attribute value, the identifier, and a current live stream interface view to a target server, to cause the target server to perform rendering processing on the current live stream interface view based on a gift effect rendering algorithm corresponding to the identifier; and
receive and display a view rendering result issued by the target server.

The computer-readable medium carries one or more programs that, when the one or more programs are executed by the electronic device, can further enable the electronic device:
obtain a to-be-rendered gift identifier uploaded by a live stream client that sends a gift request, and a target rendering processing image;
perform rendering processing on the target rendering processing image by a gift effect rendering algorithm corresponding to the identifier; and
send an image rendering result to a target client for display, wherein the target client comprises the live stream client that sends the gift request and a live stream client associated with the live stream client that sends the gift request.

Computer program code for performing the operations of the present disclosure may be written in one or more programming languages, or combinations thereof, including object-oriented programming languages such as Java, Smalltalk, C++, conventional procedural programming languages such as the “C” language, or similar programming languages. or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer over any kind of network, including a LAN or WAN, or it may be connected to an external computer (e.g., via an Internet connection using an Internet service provider).

The flowcharts and block diagrams in the accompanying drawings illustrate the architecture, functionality, and operation of systems, methods, and computer program products that may be implemented in accordance with various embodiments of the present disclosure. At this point, respective box in the flowcharts or block diagrams may represent a module, program segment, or portion of code that contains one or more executable instructions for implementing a specified logical function. It should also be noted that in some implementations that are determined to be substitutions, the functions indicated in the boxes may also occur in a different order than that indicated in the accompanying drawings. For example, two consecutively represented boxes may actually be executed substantially in parallel, and they may sometimes be executed in reverse order, depending on the function involved. It should also be noted that respective of the boxes in the block diagrams and I or flowcharts, as well as combinations of the boxes in the block diagrams and I or flowcharts, may be implemented in a dedicated hardware-based system that performs the specified function or operation, or may be implemented in a combination of dedicated hardware and computer instructions.

Units described as being involved in embodiments of the present disclosure may be implemented by way of software or may be implemented by way of hardware. Wherein the name of a unit does not in some cases constitute a limitation of the unit itself, for example, a first obtaining unit may also be described as “a unit for obtaining at least two Internet Protocol addresses”.

The functions described above herein may be performed, at least in part, by one or more hardware logic components. For example, exemplary types of hardware logic components that may be used include: Field Programmable Gate Array (FPGA), Application Specific Integrated Circuit (ASIC), Application Specific Standard Parts (ASSP), System on Chip (SOC), and System on Chip (SOC). Application Specific Standard Parts (ASSP), System on Chip (SOC), Complex Programmable Logic Device (CPLD) and so on.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may comprise an electronic, magnetic, optical, electromagnetic, infrared, or semiconductor system, device, or apparatus, or any suitable combination thereof. Machine-readable storage media may comprise an electrical connection According to one or more wires, a portable computer disk, a hard disk, a random access memory (RAM), a read-only memory (ROM), an erasable programmable read-only memory (EPROM or flash memory), a fiber optic, a compact disk-read-only memory (CD-ROM) for convenience, an optical storage device, a magnetic storage device, or any suitable combination of the foregoing. or any suitable combination thereof.

According to one or more embodiments of the present disclosure, [Example 1] provides a method for cloud rendering of a live stream gift applied to a client, the method comprising:
obtaining a to-be-rendered gift identifier and determining an attribute value of a gift effect corresponding to the identifier;
uploading, based on the attribute value, the identifier, and a current live stream interface view to a target server, to cause the target server to perform rendering processing on the current live stream interface view based on a gift effect rendering algorithm corresponding to the identifier; and
receiving and displaying a view rendering result issued by the target server.

According to one or more embodiments of the present disclosure, [Example 2] provides a method for cloud rendering of a live stream gift applied to a client, further comprising:
for example, the attribute value comprising a gift effect rendering algorithm complexity, and the uploading, based on the attribute value, the identifier, and a current live stream interface view to a target server, comprising:
in accordance with a determination that the gift effect rendering algorithm complexity reaches a predetermined cloud rendering complexity criterion, uploading the identifier and the current live stream interface view to the target server.

According to one or more embodiments of the present disclosure, [Example 3] provides a method for cloud rendering of a live stream gift applied to a client, further comprising:
for example, in accordance with a determination that the gift effect rendering algorithm complexity reaches a predetermined cloud rendering complexity criterion, the method further comprising:
playing an effect teaser animation corresponding to the identifier until the view rendering result issued by the target server is received.

According to one or more embodiments of the present disclosure, [Example 4] provides a method for cloud rendering of a live stream gift applied to a client, further comprising:
for example, in accordance with a determination that the view rendering result issued by the target server has not been received within a predetermined period, playing an alternative effect animation corresponding to the identifier.

According to one or more embodiments of the present disclosure, [Example 5] provides a method for cloud rendering of a live stream gift applied to a client, further comprising:
for example, when obtaining a to-be-rendered gift identifier, identify a computing performance of a device where the client is located;
in accordance with a determination that the computing performance satisfies a criterion for running a gift effect rendering algorithm corresponding to the identifier, capture the current live stream interface view, and obtain the gift effect rendering algorithm corresponding to the identifier; and
render the current live stream interface view based on the gift effect rendering algorithm corresponding to the identifier and displaying the rendering result.

According to one or more embodiments of the present disclosure, [Example 6] provides a method for cloud rendering of a live stream gift applied to a server, comprising:
obtaining a to-be-rendered gift identifier uploaded by a live stream client that sends a gift request, and a target rendering processing image;
performing rendering processing on the target rendering processing image by a gift effect rendering algorithm corresponding to the identifier; and
sending an image rendering result to a target client for display, wherein the target client comprises the live stream client that sends the gift request and a live stream client associated with the live stream client that sends the gift request.

According to one or more embodiments of the present disclosure, [Example 7] provides a method for cloud rendering of a live stream gift applied to a server, further comprising:
for example, performing rendering processing on the target rendering processing image by the gift effect rendering algorithm corresponding to the identifier comprising:
performing, by starting at least one thread, synchronous rendering processing on the target rendering processing image that passes a content review, based on content of the gift effect rendering algorithm corresponding to the identifier.

According to one or more embodiments of the present disclosure, [Example 8] provides a method for cloud rendering of a live stream gift applied to a server, further comprising:
for example, sending an image rendering result to a target client for display comprising:
sending an end-of-rendering notification message to the target client to cause the target client to display the image rendering result.

According to one or more embodiments of the present disclosure, [Example 9] provides an apparatus for cloud rendering of live stream gift, the apparatus being configured on a client and comprising:
a rendering attribute determination module configured to obtain a to-be-rendered gift identifier and determining an attribute value of a gift effect corresponding to the identifier;
a cloud rendering initiation module configured to upload, based on the attribute value, the identifier, and a current live stream interface view to a target server, to cause the target server to perform rendering processing on the current live stream interface view based on a gift effect rendering algorithm corresponding to the identifier; and
a rendering result display module configured to receive and display a view rendering result issued by the target server.

According to one or more embodiments of the present disclosure, [Example 10] provides an apparatus for cloud rendering of live stream gift, the apparatus being configured on a client and further comprising:
for example, the attribute value comprising a gift effect rendering algorithm complexity, and the cloud rendering initiation module configured to:
in accordance with a determination that the gift effect rendering algorithm complexity reaches a predetermined cloud rendering complexity criterion, uploading the identifier and the current live stream interface view to the target server.

According to one or more embodiments of the present disclosure, [Example 11] provides an apparatus for cloud rendering of live stream gift, the apparatus being configured on a client and further comprising:
for example, the cloud rendering initiation module further configured to: in accordance with a determination that the gift effect rendering algorithm complexity reaches a predetermined cloud rendering complexity criterion, play an effect teaser animation corresponding to the identifier until the view rendering result issued by the target server is received.

According to one or more embodiments of the present disclosure, [Example 12] provides an apparatus for cloud rendering of live stream gift, the apparatus being configured on a client and further comprising:
for example, the rendering result display module further configured to:
in accordance with a determination that the view rendering result issued by the target server has not been received within a predetermined period, playing an alternative effect animation corresponding to the identifier.

According to one or more embodiments of the present disclosure, [Example 13] provides an apparatus for cloud rendering of live stream gift, the apparatus being configured on a client and further comprising:
for example, the apparatus for cloud rendering of live stream gift configured on the client further comprises a local rendering module configured to:
when obtaining a to-be-rendered gift identifier, identify a computing performance of a device where the client is located;
in accordance with a determination that the computing performance satisfies a criterion for running a gift effect rendering algorithm corresponding to the identifier, capture the current live stream interface view, and obtain the gift effect rendering algorithm corresponding to the identifier; and
render the current live stream interface view based on the gift effect rendering algorithm corresponding to the identifier and displaying the rendering result.

According to one or more embodiments of the present disclosure, [Example 14] provides an apparatus for cloud rendering of live stream gift, the apparatus being configured on a server and comprising:
a cloud rendering startup module configured to obtain a to-be-rendered gift identifier uploaded by a live stream client that sends a gift request, and a target rendering processing image;
a cloud rendering module configured to a perform rendering processing on the target rendering processing image by the gift effect rendering algorithm corresponding to the identifier; and a cloud rendering result feedback module configured to send an image rendering result to a target client for display, wherein the target client comprises the live stream client that send a gift request and a live stream client associated with the live stream client that send a gift request.

According to one or more embodiments of the present disclosure, [Example 15] provides an apparatus for cloud rendering of live stream gift, the apparatus being configured on a server and further comprising:
for example, the cloud rendering module configured to:
perform, by starting at least one thread, synchronous rendering processing on the target rendering processing image that passes a content review, based on content of the gift effect rendering algorithm corresponding to the identifier.

According to one or more embodiments of the present disclosure, [Example 16] provides an apparatus for cloud rendering of live stream gift, the apparatus being configured on a server and further comprising:
for example, the cloud rendering result feedback module configured to:
send an end-of-rendering notification message to the target client to cause the target client to display the image rendering result.

Furthermore, although a plurality of operations is depicted in a particular order, this should not be construed as requiring that the operations be performed in the particular order shown or in sequential order of performance. In certain environments, multitasking and parallel processing may be advantageous. Similarly, while a plurality of implementation details is included in the above discussion, these should not be construed as limiting the scope of the present disclosure. Some of the features described in the context of separate embodiments may also be implemented in combination in a single embodiment. Conversely, a plurality of features described in the context of a single embodiment may also be implemented in a plurality of embodiments, either individually or in any suitable sub-combination.

1. A method for cloud rendering of a live stream gift, the method being applied to a client and comprising:
obtaining a to-be-rendered gift identifier and determining an attribute value of a gift effect corresponding to the identifier;
uploading, based on the attribute value, the identifier, and a current live stream interface view to a target server, to cause the target server to perform rendering processing on the current live stream interface view based on a gift effect rendering algorithm corresponding to the identifier; and
receiving and displaying a view rendering result issued by the target server.

2. The method of claim 1, wherein the attribute value comprises a gift effect rendering algorithm complexity: and
wherein uploading, based on the attribute value, the identifier, and a current live stream interface view to a target server comprises:
in response to a determination that the gift effect rendering algorithm complexity reaches a predetermined cloud rendering complexity criterion, uploading the identifier and the current live stream interface view to the target server.

3. The method of claim 2, in response to a determination that the gift effect rendering algorithm complexity reaches a predetermined cloud rendering complexity criterion, the method further comprising:
playing an effect teaser animation corresponding to the identifier until the view rendering result issued by the target server is received.

4. The method of claim 1, further comprising:
in response to a determination that the view rendering result issued by the target server has not been received within a predetermined period, playing an alternative effect animation corresponding to the identifier.

5. The method of claim 1, when obtaining a to-be-rendered gift identifier, wherein the method further comprises:
identifying a computing performance of a device where the client is located;
in response to a determination that the computing performance satisfies a criterion for running a gift effect rendering algorithm corresponding to the identifier, capturing the current live stream interface view, and obtaining the gift effect rendering algorithm corresponding to the identifier; and
rendering the current live stream interface view based on the gift effect rendering algorithm corresponding to the identifier and displaying the rendering result.

6. A method for cloud rendering of live stream gift, the method being applied to a server and comprising:
obtaining a to-be-rendered gift identifier uploaded by a live stream client that sends a gift request, and a target rendering processing image:
performing rendering processing on the target rendering processing image by a gift effect rendering algorithm corresponding to the identifier; and
sending an image rendering result to a target client for display, wherein the target client comprises the live stream client that sends the gift request and a live stream client associated with the live stream client that sends the gift request.

7. The method of claim 6, wherein performing rendering processing on the target rendering processing image by the gift effect rendering algorithm corresponding to the identifier comprises:
performing, by starting at least one thread, synchronous rendering processing on the target rendering processing image that passes a content review, based on content of the gift effect rendering algorithm corresponding to the identifier.

8. The method of claim 6, wherein sending an image rendering result to a target client for display comprises:
sending an end-of-rendering notification message to the target client to cause the target client to display the image rendering result.

9. (canceled)

10. (canceled)

11. An electronic device, comprising:
one or more processors; and
a storage device configured to store one or more programs:
wherein the one or more programs, when executed by the one or more processors, cause the one or more processors to implement a method for cloud rendering of live stream gift comprising:
obtaining a to-be-rendered gift identifier and determining an attribute value of a gift effect corresponding to the identifier;
uploading, based on the attribute value, the identifier, and a current live stream interface view to a target server, to cause the target server to perform rendering processing on the current live stream interface view based on a gift effect rendering algorithm corresponding to the identifier; and
receiving and displaying a view rendering result issued by the target server.

12. (canceled)

13. The electronic device of claim 11, wherein the attribute value comprises a gift effect rendering algorithm complexity; and
wherein uploading, based on the attribute value, the identifier, and a current live stream interface view to a target server comprises:
in response to a determination that the gift effect rendering algorithm complexity reaches a predetermined cloud rendering complexity criterion, uploading the identifier and the current live stream interface view to the target server.

14. The electronic device of claim 13, in response to a determination that the gift effect rendering algorithm complexity reaches a predetermined cloud rendering complexity criterion, wherein the method further comprises:
playing an effect teaser animation corresponding to the identifier until the view rendering result issued by the target server is received.

15. The electronic device of claim 11, wherein the method further comprises:
in response to a determination that the view rendering result issued by the target server has not been received within a predetermined period, playing an alternative effect animation corresponding to the identifier.

16. The electronic device of claim 11, when obtaining a to-be-rendered gift identifier, wherein the method further comprises:
identifying a computing performance of a device where the client is located:
in response to a determination that the computing performance satisfies a criterion for running a gift effect rendering algorithm corresponding to the identifier, capturing the current live stream interface view, and obtaining the gift effect rendering algorithm corresponding to the identifier; and
rendering the current live stream interface view based on the gift effect rendering algorithm corresponding to the identifier and displaying the rendering result.

17. The electronic device of claim 11, wherein the attribute value further comprises a data volume of gift effect rendering resources; and
wherein uploading, based on the attribute value, the identifier, and a current live stream interface view to a target server comprises:
in response to a determination that the data volume of gift effect rendering resources reaches a predetermined cloud rendering complexity criterion, uploading the identifier and the current live stream interface view to the target server.

18. The electronic device of claim 13, wherein in response to a determination that the gift effect rendering algorithm complexity reaches a predetermined cloud rendering complexity criterion, uploading the identifier and the current live stream interface view to the target server further comprises:
determining the gift effect rendering algorithm complexity based on a size of a gift effect rendering algorithm file corresponding to the to-be-rendered gift identifier.

19. The electronic device of claim 13, wherein in response to a determination that the gift effect rendering algorithm complexity reaches a predetermined cloud rendering complexity criterion, uploading the identifier and the current live stream interface view to the target server further comprises:
evaluating the gift effect rendering algorithm complexity based on the number of lines of an effect rendering algorithm and a complexity of an invoking relationship.

20. The method of claim 1, wherein the attribute value further comprises a data volume of gift effect rendering resources; and
wherein uploading, based on the attribute value, the identifier, and a current live stream interface view to a target server comprises:
in response to a determination that the data volume of gift effect rendering resources reaches a predetermined cloud rendering complexity criterion, uploading the identifier and the current live stream interface view to the target server.

21. The method of claim 2, wherein in response to a determination that the gift effect rendering algorithm complexity reaches a predetermined cloud rendering complexity criterion, uploading the identifier and the current live stream interface view to the target server further comprises:
determining the gift effect rendering algorithm complexity based on a size of a gift effect rendering algorithm file corresponding to the to-be-rendered gift identifier.

22. The method of claim 2, wherein in response to a determination that the gift effect rendering algorithm complexity reaches a predetermined cloud rendering complexity criterion, uploading the identifier and the current live stream interface view to the target server further comprises:
evaluating the gift effect rendering algorithm complexity based on the number of lines of an effect rendering algorithm and a complexity of an invoking relationship.

23. The method of claim 1, wherein the to-be-rendered gift identifier comprises:
determining, during a process of live streaming, an identifier of a selected and triggered effect gift on a client interface as the to-be-rendered gift identifier.
